(19) United States
(12) Patent Application Publication
(10) Pub. No.: US 2024/0311119 A1
(43) Pub. Date: Sep. 19, 2024

(54) RUNTIME LAYER OPERATING CONVERGENCE LOOP FOR APPLICATION DEPLOYMENT AND ROLLBACK

(71) Applicant: Prodvana, San Francisco, CA (US)

(72) Inventors: Naphat Sanguansin, San Francisco, CA (US); Andrew Yee Yee Fong, San Francisco, CA (US)

(21) Appl. No.: 18/434,452

(22) Filed: Feb. 6, 2024

Related U.S. Application Data
(60) Provisional application No. 63/489,934, filed on Mar. 13, 2023.

(51) Int. Cl. G06F 8/61

(52) U.S. Cl. CPC G06F 8/61

(57) ABSTRACT

A tool is disclosed for orchestrating application protocol interfaces (APIs) of an infrastructure layer and an application layer using a runtime layer between the infrastructure layer and the application layer, the method comprising. The tool receives, from the application layer, configuration information for a service, the configuration information received using the runtime layer, and accesses a database storing a plurality of cluster capabilities available for operating the service, the database populated by the runtime layer maintaining a state of capabilities for each of the plurality of clusters. The tool determines deployment conditions for the service and instantiates a convergence loop that monitors for each deployment condition of the plurality of deployment conditions in parallel. The tool determines that convergence has occurred based on each of the deployment conditions being met, and responsively instructs the infrastructure layer to implement the service.

### CROSS-REFERENCE TO RELATED APPLICATION

The application claims benefit of priority to U.S. Provisional Application No. 63/489,934, filed Mar. 13, 2023, which is hereby incorporated by referenced in its entirety.

### TECHNICAL FIELD

The disclosure generally relates to the field of application deployment, and more particularly relates to converging to defined states spanning both the application layer and the infrastructure layer in automatic application deployment while enforcing constraints.

### BACKGROUND

Typical service deployments suffer limitations in terms of constructing the deployment and rigidity of deployment. For example, typically an infrastructure team is given parameters from various other teams to build a service deployment pipeline, and builds that pipeline from scratch. When the deployment pipeline is built, it is static in nature, where if a component of the pipeline fails, the entire deployment pipeline needs to be assessed from the top to identify the point of failure given complex interdependencies between components. Moreover, where an underlying infrastructure change needs to be made, such as a cluster needing to be spun up or a cluster upgrade needs to be made, the service needs to be redeployed using the full pipeline, going unnecessarily through all stages.

### SUMMARY

Systems and methods are disclosed herein for deploying a convergence tool using a runtime layer between an application layer and infrastructure layer. The convergence tool (e.g., using the runtime layer) may accept parameters at the application from entities that are not part of an infrastructure team, and may determine deployment conditions therefrom. The convergence tool (e.g., using the runtime layer) may also accept commands from the infrastructure layer in terms of what clusters to utilize and other constraints and conditions relating to infrastructure that must be met. The convergence tool (e.g., using data informed from the runtime layer for operating a delivery engine layer) may determine each component for deploying a service, and despite interdependencies between components, may run a convergence loop that independently determines whether each component meets all preconditions. The convergence tool (e.g., using the delivery engine layer as informed from activity of the runtime layer) may determine that convergence has occurred responsive to determining that all components meet their respective preconditions.

In an embodiment, a convergence tool leverages a runtime layer sitting between an infrastructure layer and an application layer in order to orchestrate application protocol interfaces (APIs) of the infrastructure layer and the application layer in deploying a service. The convergence tool (e.g., using the runtime layer) receives, using an API of the application layer, configuration information for a service. The convergence tool (e.g., using the runtime layer) accesses a database storing a plurality of cluster capabilities available for operating the service, the database populated by the runtime layer maintaining a state of capabilities for each of the plurality of clusters. The convergence tool (e.g., using the runtime layer) determines, from the configuration information, a plurality of deployment conditions for the service. The convergence tool (e.g., using a delivery engine layer as informed by activity of the runtime layer) instantiates a convergence loop, the convergence loop monitoring for each deployment condition of the plurality of deployment conditions in parallel. The convergence tool (e.g., using the delivery engine layer as informed by activity of the runtime layer) determines that convergence has occurred based on each of the deployment conditions being met. In response to determining that convergence has occurred, the convergence tool (e.g., using the delivery engine layer as informed by activity of the runtime layer) instructs, using an API of the infrastructure layer, the infrastructure layer to implement the service.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing a convergence tool.

FIG. 2 illustrates one embodiment of modules of the convergence tool.

FIGS. 3A-3C illustrate exemplary user interfaces for defining parameters for an application, in accordance with an embodiment.

FIGS. 4A-4B illustrate exemplary user interfaces for adding a service, in accordance with an embodiment.

FIGS. 5A-5C illustrate exemplary user interfaces showing activity during a convergence loop, in accordance with an embodiment.

FIG. 6 illustrates an exemplary workflow for configuring and deploying a service, in accordance with an embodiment.

FIG. 7 is a block diagram illustrating components of an example machine able to read instructions from a machine-readable medium and execute them in a processor (or controller).

FIG. 8 is an exemplary process for running the convergence tool, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

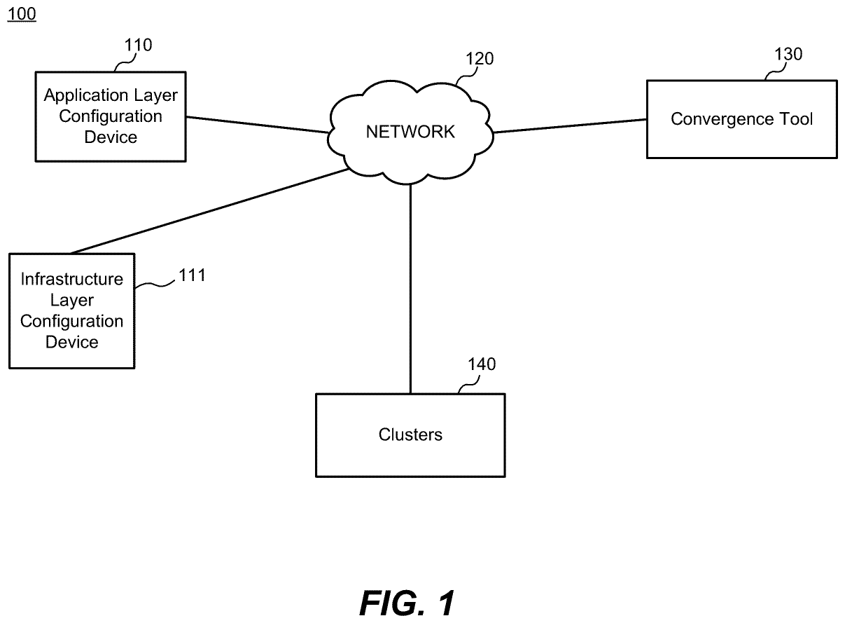

FIG. 1 illustrates one embodiment of a system environment for implementing a convergence tool. As depicted in FIG. 1, environment 100 includes application layer configuration device 110, infrastructure layer configuration device 111, network 120, convergence tool 130, and clusters 140. Application layer configuration device 110 and infrastructure layer configuration device 111 may belong to a same domain, such as a conglomerate that divides people within its domain into different teams (e.g., application layer configuration device 110 may be operated by a person in legal; infrastructure layer configuration device 111 may be operated by a person in infrastructure). Application layer configuration device 110 and infrastructure layer configuration device 111 may be client devices. The term client device, as used herein, may refer to a device having a user interface that accepts parameters for an application and interfaces with convergence tool 130 for implementing those parameters (e.g., via network 120). Exemplary client devices include smartphones, laptops, kiosks, personal computers, wearable devices, and any other device that performs the functionality described herein.

Network 120 may be any data conduit that allows communication between application layer configuration device 110, infrastructure layer configuration device 111, convergence tool 130, clusters 140, and any other network-enabled device. Network 120 may be any combination of the Internet, WiFi, Bluetooth, local area network (LAN), or any other data conduit suitable for transmitting communications that facilitate the functionality disclosed herein.

Convergence tool 130 orchestrates application protocol interfaces (APIs) of an infrastructure layer and an application layer by obtaining configuration parameters for an application from application layer configuration device 110 and infrastructure layer configuration device 111 via their respective APIs and determines whether the application can be deployed by running a convergence loop using those configuration parameters. Convergence tool 130 may also detect that convergence has ended, and may responsively roll back a deployment (e.g., to a last known working version), thus preventing failure from deployment modifications and additions of new parameters. Convergence tool 130 operates at a runtime layer that sits between an application layer and an infrastructure layer of an application in determining and establishing protections for convergence, and may operate at other layers, such as a delivery engine layer, for determining whether convergence has occurred or has been departed from. The application could be any web service, such as a web server that runs on top of any cloud service provider capability such as Kubernetes, lambda, and so on. The application may be configured using one or more docker files.

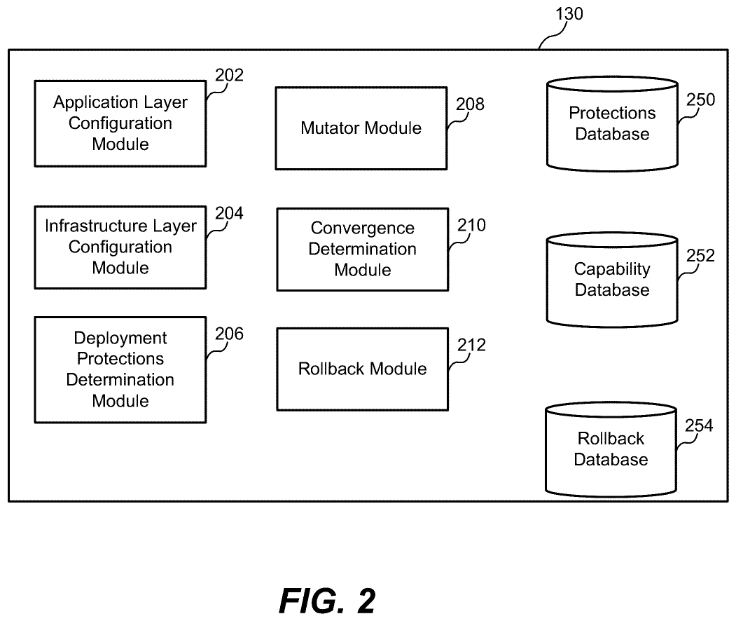

Applications may be deployed using clusters 140. Clusters 140 include resources (e.g., on-prem, cloud, or a combination thereof) for performing application tasks of an enterprise. The resources may span different cloud providers, each cloud provider having a different schema. Convergence tool 130 may receive abstracted configuration parameters and use connectors to provision different clusters 140 in their respective correct schema. Further details of the entities of environment 100 are disclosed below with reference to FIGS. 2-8.

FIG. 2 illustrates one embodiment of modules of the convergence tool. As depicted in FIG. 2, convergence tool 130 includes application layer configuration module 202, infrastructure layer configuration module 204, deployment protections determination module 206, mutator module 208, convergence determination module 210, rollback module 212, precondition database 250, capability database 252, and rollback database 254. The modules and databases depicted in FIG. 2 are merely exemplary; fewer or more modules and/or databases may be used to achieve the functionality described herein.

Application configuration module 202 receives configuration information for a service using an API of the application layer (e.g., to facilitate receiving communications from application layer communication device 110). The configuration information may include one or more protections for deploying the service or a portion thereof. The term protection(s), as used herein, may refer to attributes used to determine convergence. Exemplary protections may include preconditions, approvals, post-conditions, and the like. For example, a convergence loop may include obtaining preconditions for a service, which may be conditions that must be met before a service can begin to be deployed.

As an example of a precondition, a person operating in legal may indicate constraints on how personal information can be stored and used in Europe, as opposed to different constraints pertaining to the United States, due to differences in privacy laws. The downstream effect of this is application configuration module 202 responsively preconfigures the service to enforce these constraints by establishing a precondition that reads container image metadata (e.g., metadata of new updates to the application) to determine deployment location, and to reject pushes to the application that use an image built for the wrong geography (e.g., by checking what the image imposes on user location data against the precondition to inform what to reject). Application configuration module 202 may generate configuration information indicating protections to impose on new images pushed to an application based on the input received from the application layer and may store those to protections database 250.

Following along from generating protections, approvals may be indicated as protections. For example, a user may indicate that after preconditions are met, a human (or multiple humans) must review and approve deployment before deployment occurs. Such approval protections may include specifying particular humans to approve, and/or specifying a credential of a human to be eligible to approve (e.g., a person from the legal department, from the information technology department, and so on). Application protection module 202 may store such protections to protections database 250. This enables a downstream operation of convergence tool 130 to, responsive to determining that preconditions for a service are satisfied, determine one or more client devices corresponding to humans indicated in approval protections, and may transmit electronic communications causing prompts to those humans, where responsive to receiving approval, convergence tool 130 may allow for deployment of the service.

Protections may also include post-conditions, which are conditions that are required to be met for convergence continue to be met. Exemplary post-conditions may include network conditions (e.g., minimum throughput, maximum latency, etc.), service conditions (e.g., dependent service continues to satisfy certain conditions), infrastructure conditions (e.g., cloud service provider resource levels satisfy minimum thresholds), or any other post-conditions. Again, post-conditions may be stored to protections database 250, where convergence tool 130 may enforce post-conditions following deployment. Convergence tool 130 may enforce post-conditions by rolling back services or failing services, as is described in further detail below.

Infrastructure layer configuration module 204 accesses a database storing a plurality of cluster capabilities available for operating the service, the database populated by the runtime layer (that is, convergence tool 130) maintaining a state of capabilities for each of the plurality of clusters. Infrastructure layer configuration module 204 populates capability database 252 based on configuration received for the infrastructure layer. For example, an infrastructure team including perhaps a network architect generates input for infrastructure layer configuration module 204 indicating what cloud service providers and what underlying resources therein can be used to run the application. Infrastructure layer configuration module 204 may also receive input on protections for deploying a service from the infrastructure team, such as an indication of dependent services as well as minimum parameters for each dependent service.

In an embodiment, convergence layer 130 crawls images to automatically determine dependencies between services of an application. For example, where services contain pointers to other services, convergence layer 130 determines that there is a dependency. Dependencies may be stored to capability database 252. In some embodiments, the dependencies may be stored to a dynamic acyclic graph (DAG) structure that has directed edges between service nodes that represent dependencies, where the DAG may be referenced to determine upstream and downstream dependencies for convergence. The DAG may in some cases show a present convergence status at each edge, where edges in the graph may represent an entity (e.g., service) needing or not needing another entity to be converged before the entity can itself be considered converged. Convergence layer may 130 have default conditions for known service types along a dependency chain stored to capability database 252 (e.g., where a canary service is used to determine network health, the canary service may have a condition that it sees at least a threshold percentage (e.g., 1%) of its network traffic successfully processed before a service depending on the canary service can begin deployment). Convergence layer 130 may, additionally or alternatively, receive configuration information from the infrastructure team on constraints for each dependent service that must be met before a higher order service can be deployed, and this configuration information may be stored to protections database 252. The protections may include preconditions for cloud service provider resources (e.g., a cloud service provider resource used to deploy an application must have istio, or argo, or a combination of features). The protections may include whether a human should confirm or override a deployment after convergence is reached before the deployment occurs.

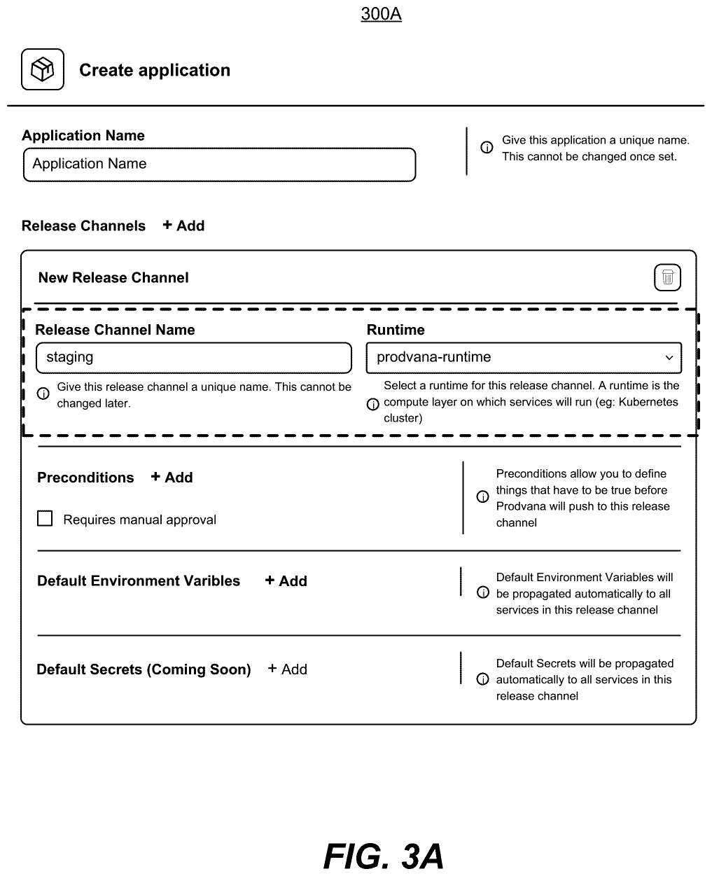

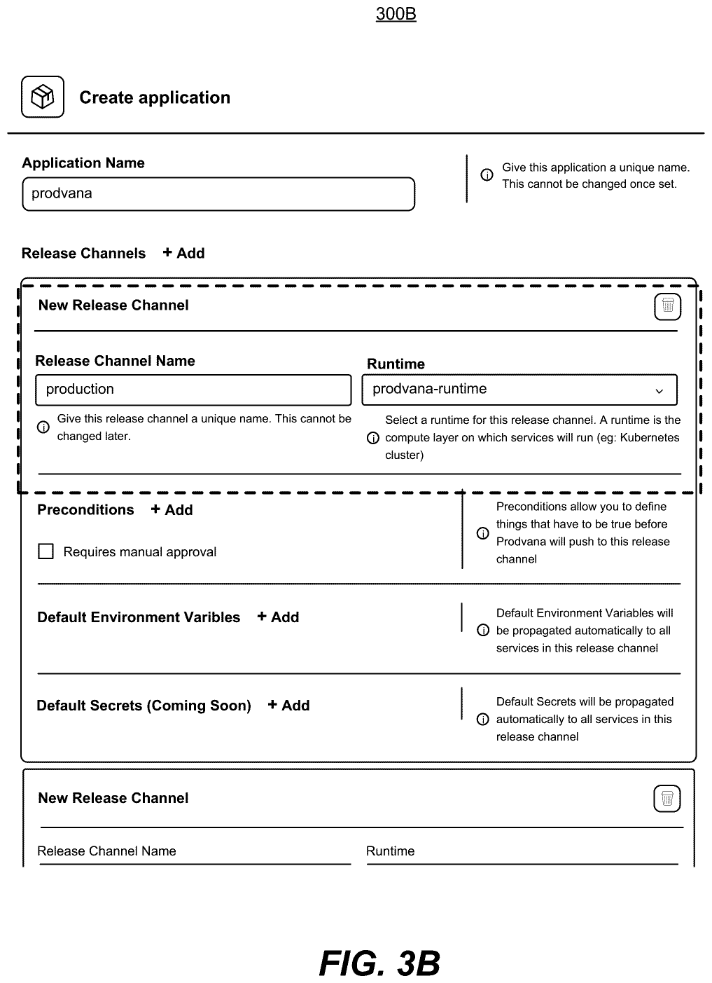

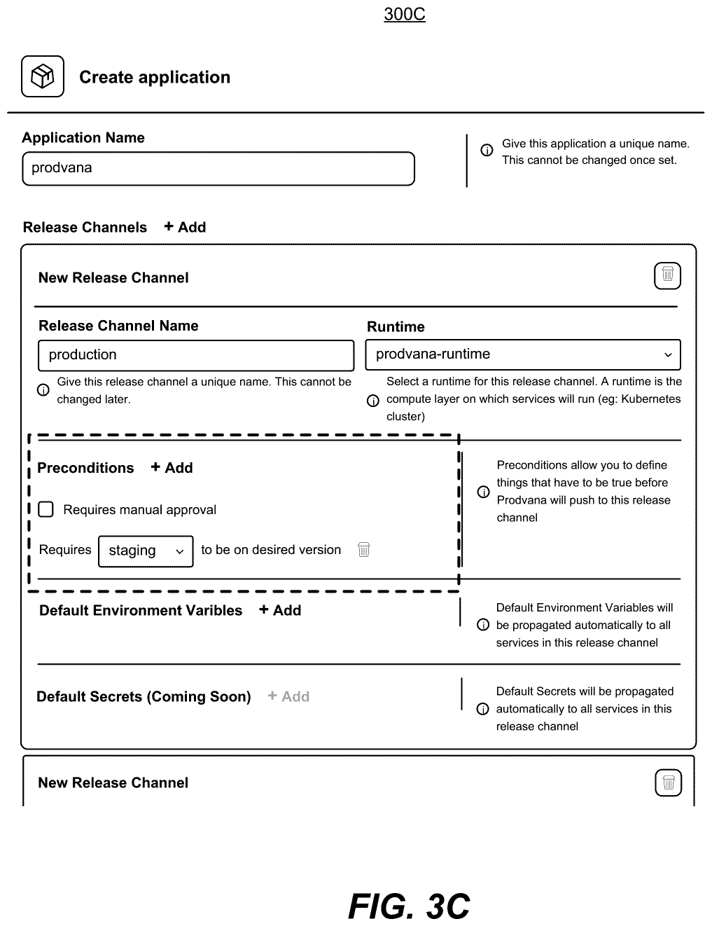

To show more detail on activity of infrastructure layer configuration module 204, we briefly turn to FIGS. 3A-3C, which illustrate exemplary user interfaces for defining parameters for an application, in accordance with an embodiment. FIG. 3A, as depicted, shows user interface 300A for creating conditions for an application by an infrastructure layer configuration device 111. Interface 300A shows a name for a release channel of the application, and a runtime selection tool for the release channel. The term release channel, as used herein, may refer to a user-facing instance of an application. The runtime selection tool may include selection of one or more resource types (e.g., types of clusters of clusters 140, such as a Kubernetes cluster or a lambda cluster). Different release channels and preconditions may be established for different aspects of an application. For example, in FIG. 3A, a release channel and corresponding preconditions may be established for a staging phase of the application. As shown interface 300B of FIG. 3B on the other hand, a different release channel and corresponding preconditions and other configuration parameters may be established for a production phase.

As shown in FIG. 3C, regardless of which phase a release channel applies to, infrastructure layer configuration module 204 may receive preconditions for that channel. For example, interface 300C of FIG. 3C shows that a production phase of the application can be deployed according to a precondition that staging is on a particular version. This creates a dependency from the production phase to the staging phase. Any number of preconditions may be selected for the production phase service of the application deployment (e.g., as depicted in interface 300C, manual approval can be selected as a requirement). Infrastructure layer configuration module 204 may store these preconditions and configuration settings to protections database 250 and/or capability database 252 as appropriate.

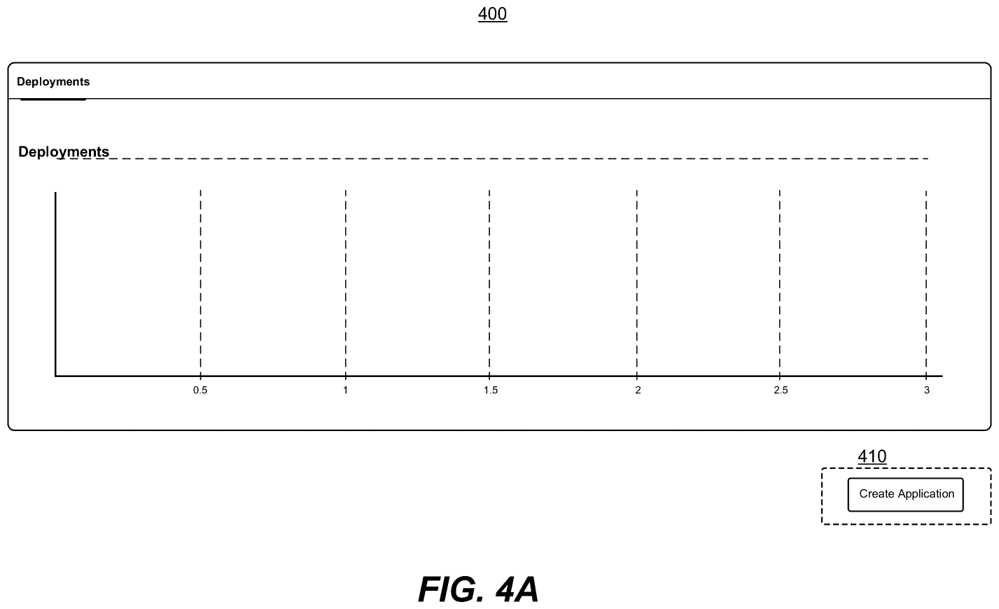

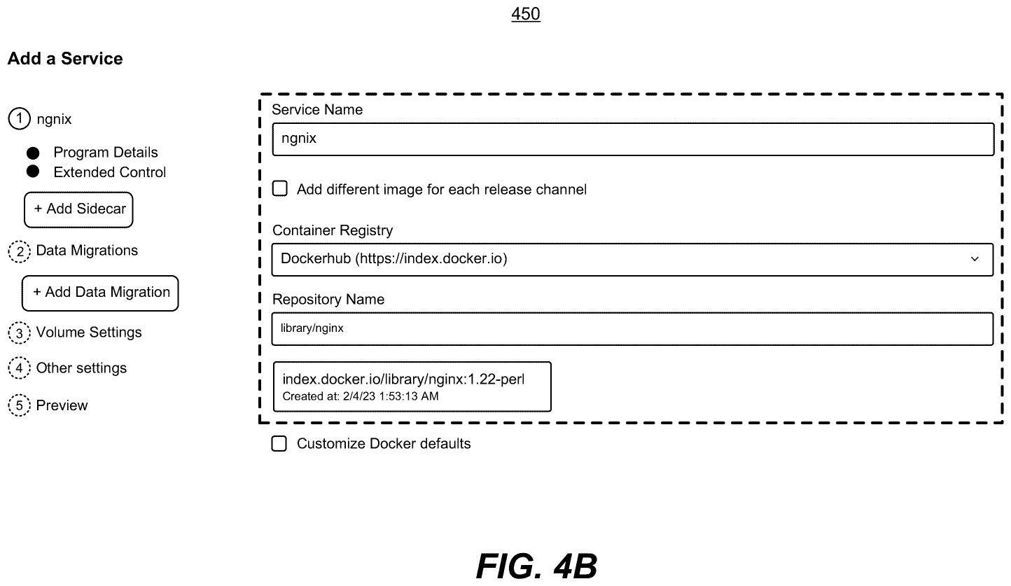

At deployment, deployment protections determination module 206 determines, for an application that is to be deployed, a set of protections that applies to the deployment (e.g., by referencing precondition database 250 and/or capability database 252). To facilitate explanation, we now briefly turn FIGS. 4A-4B, which illustrate exemplary user interfaces for adding a service, in accordance with an embodiment. User interface 400 of FIG. 4A includes user interface 40, which shows active deployments, along with selectable option 410 for creating or deploying an application or update thereto. The deployment may be for an entire application, or just for a particular service of the application.

Moving to FIG. 4B, user interface 430 shows a user interface for adding a service to an application. The activity described with respect to FIG. 4B is optional, and in some embodiments, rather than the process described with respect to FIG. 4B, a convergence tool 130 may receive a config file from a user with protections parameters therein. In the embodiment of FIG. 4B, the user may input an image having code and/or pointing to code for the service. The image may be a docker image built from a docker file or any other standardized code artifact. FIG. 4B may accept input of an image from any user, such as a member of an infrastructure team, by any input means available (e.g., drag and drop, navigate a directory, etc.). Responsive to obtaining the image, deployment protections determination module 206 may reference determine the services along a dependency chain of what is to be deployed, and may determine protections for those services (e.g., referencing protections database 250 and/or capability database 252). Deployment protections determination module 206 may cache those protections in association with their respective services for reference by convergence determination module 210, and then next steps (e.g., staging and provisioning of the service) may begin.

Protections database 250 and/or capability database 252 may store information in abstracted form. Moreover, deployment images may be read by deployment protections determination module 206 in abstract form. Mutator module 208 may determine which of clusters 140 are to be used in deploying an application or in deploying a given service, and may apply a connector to mutate from abstract form to data schema of the given cluster. Storing in abstract form enables deduplication of conditions and capability information in protections database 250 and capability database 252 by avoiding a need to store different copies of this information in different data schema, improving efficiency in computation and storage capacity.

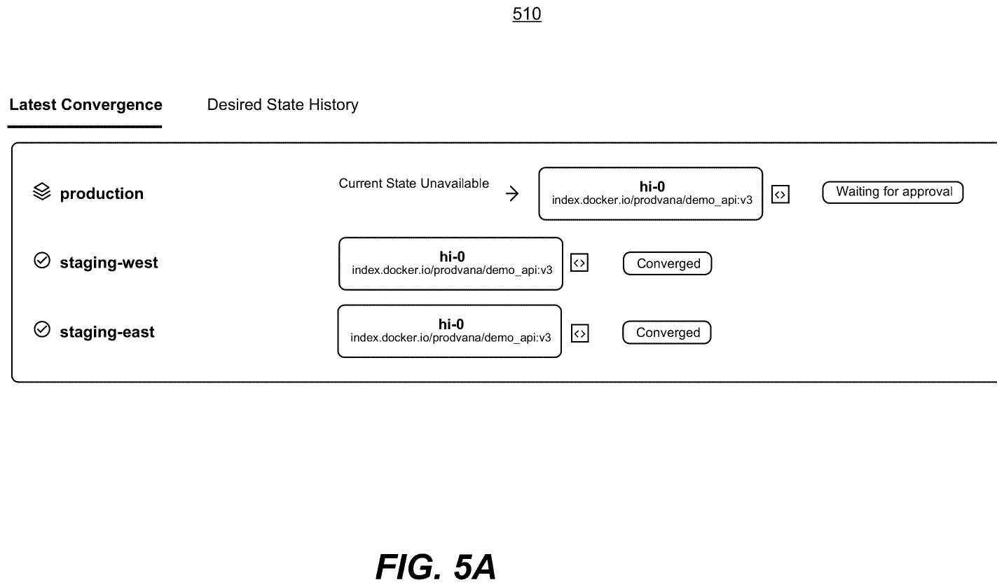

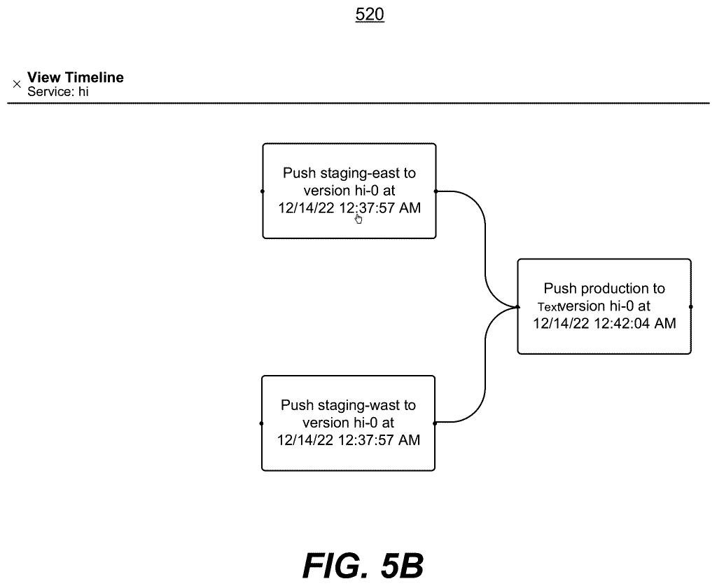

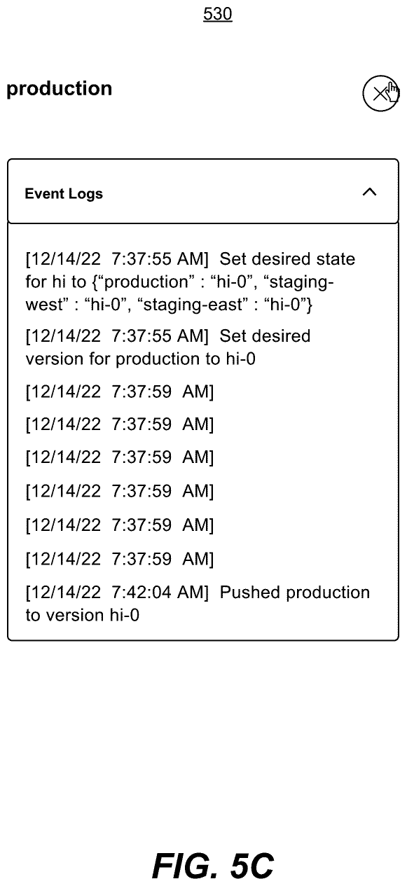

Convergence determination module 210 instantiates a convergence loop, the convergence loop monitoring for each deployment protection of the plurality of deployment protections in parallel. The term convergence loop, as used herein, may refer to a cycle that runs and checks each precondition of a deployment until all preconditions are met, and performs all activity (e.g., prompt human for approval) or wait on external actions that is required in satisfying convergence. Convergence refers to a scenario where each implicated service has met all requirements. To illustrate the operation of convergence determination module 210, we briefly turn to FIGS. 5A-5C, which illustrate exemplary user interfaces showing activity during a convergence loop, in accordance with an embodiment. A convergence loop may follow deployment, monitoring for post-conditions and re-convergence thereafter.

As shown in user interface 510 of FIG. 5A, there are three release channels that relate to those discussed above with reference to FIGS. 3 and 4. As an example, an infrastructure team indicates that staging occurs in the east and west, and staging in both east and west are a prerequisite to production. Staging in the east involves Europe, which has specific privacy requirements. Thus, staging in the east requires whatever preconditions that were specified by the infrastructure team to be met, and also requires that no code violates the specific privacy requirements, which may have been input at the application layer (e.g., by a member of a legal team). User interface 510 shows that all requirements are met for staging in the west and the east (both infrastructure layer and application requirements and preconditions). All requirements of the production service are met as well, as the requirement is that staging has converged in east and west. However, in this embodiment, a precondition is that a human approves deployment of the production before it deploys. Therefore, it is indicated that production is pending approval from a human (e.g., an approval protection). A human may be pushed a notification with a selectable option that, when selected authorizes deployment.

Moving on to FIG. 5B, user interface 520 shows a dependency graph including a timeline. The time stamps in user interface 520 show when each dependent service converged. In an embodiment, user interface 520 may also show the status of each of the protections (e.g., whether pre-conditions, approvals, and post-conditions have failed, converged, or are pending). The nodes in the graph may form selectable options that, when selected, lead to event logs for the given service. For example, moving to FIG. 5C, within user interface 530 is an event log for the production service, which shows detection of completion of staging in the east and the west, and ultimately pushing of the production (e.g., after human approval).

Convergence determination module 210 ultimately determines that convergence has occurred based on each of the deployment conditions being met. In response to determining that convergence has occurred, convergence determination module 210 instructs, using an API of the infrastructure layer, the infrastructure layer to implement the service.

In an embodiment, convergence determination module 210 may deploy “fetch” and “apply” functions to effect a convergence loop. Going back to the DAG implementation to track dependencies, fetch and apply functions may leverage the DAG to effect a convergence loop. The convergence loop may have pre-deployment, deployment, and post-deployment phases, where an entity (e.g., as service that is to run) may start in a pre-deployment phase. During the pre-deployment phase, convergence determination module 210 may instruct the entity may wait for any pre-deployment dependencies (e.g., other entities from which the service depends) to reach a converged state before entity itself is moved to a deployment phase. Convergence determination module 210 may, responsive to determining that pre-deployment is complete, fetch state of dependencies of the entity from the DAG to determine whether any of those states are not converged to the required state for deployment to occur. Where all states are converged at the outset, the deployment phase is skipped and convergence determination module 210 determines that the entity is already converged and ready for the post-deployment phase. Where all states are not converged at the outset, the fetch function repeats (e.g., continuously, periodically, or aperiodically) until all dependent states are converged.

Where required, in tandem with each fetch function, an “apply” function may be deployed to make changes (e.g., move sensitive information to a correct geographical database) that are required for convergence, and then a new fetch function may determine whether convergence has occurred. Responsive to the fetch function returning convergence on all dependencies, convergence determination module 210 determines that the deployment lifecycle is complete.

In a post-deployment phase, convergence determination module 210 may instruct the entity to wait to deploy until any post-deployment dependencies reach converged state (e.g., human approves final deployment where required). Convergence determination module 210 may determine that post-deployment dependencies have converged by fetching the state of the DAG for those dependencies and determining that the state shows convergence, and may responsively mark the entity as converged.

Following deployment, rollback module 212 monitors each service for continued compliance with post-conditions of the relevant deployment protections. In an embodiment, as services are changed, updated, or added, rollback module 212 stores the latest version to rollback database 254 (or any other database that stores the latest version). In an embodiment, the latest version is stored in addition to older versions. In an embodiment, the latest version (once converged) replaces earlier versions. Responsive to detecting that a given service is not in compliance with at least one deployment condition of the plurality of deployment conditions, rollback module 212 rolls back the service to an earlier version. In this way, when issues are introduced (e.g., by humans in making updates that cause non-compliance, or by non-human entropy such as a cluster failing or a cloud service provider changing cluster capabilities in a manner that is non-compliant), the service does not fail, and instead rolls back to an earlier configuration. In parallel, rollback module 212 may alert an infrastructure layer as to the issue. In an embodiment, rather than roll back a service, rollback module 212 may fail the service and take no action other than alerting an infrastructure layer as to the issue.

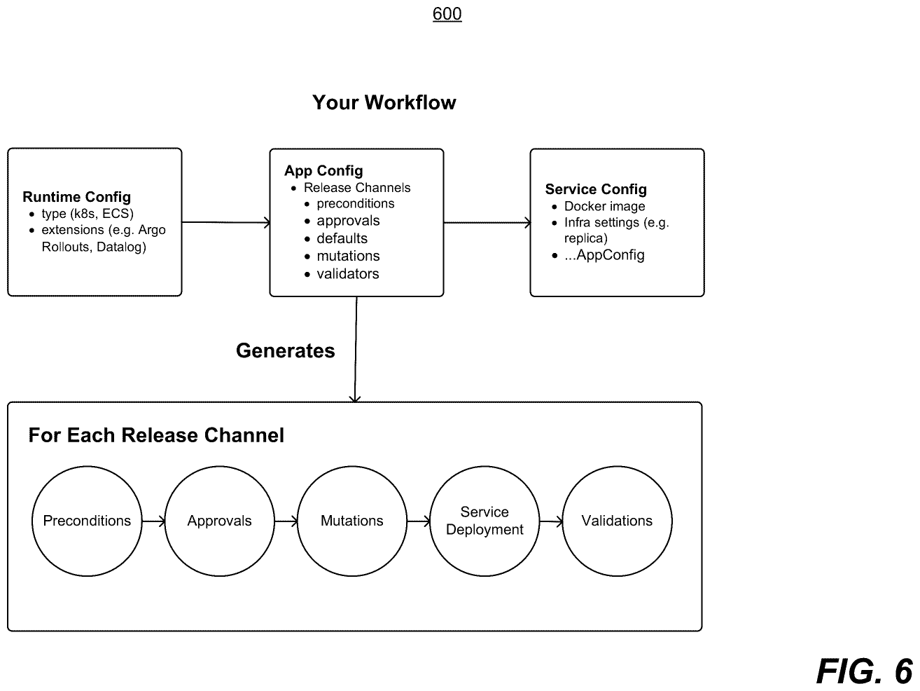

FIG. 6 illustrates an exemplary workflow for configuring and deploying a service, in accordance with an embodiment. As depicted in workflow 600, a runtime configuration is generated (e.g., from the infrastructure team) that indicates an environment in which the convergence loop will operate, including type of runtime, and extensions to the runtime. According to the runtime environment, an application layer is configured with release channels including preconditions (e.g., approvals), where some preconditions may be defaulted to. Allowed mutations and validators may be indicated within the application layer configuration. Thereafter, for release channels that enable updates to services and additional services, a workflow is established where preconditions are determined, approvals are obtained, data mutations occur after convergence where needed for different cluster schema compliance, the service (or update) is deployed, and validations occur (e.g., where rollback occurs where validation is not possible). The deployment may be further configured (e.g., using a docker image or with other updates), which may cause further convergence loops.

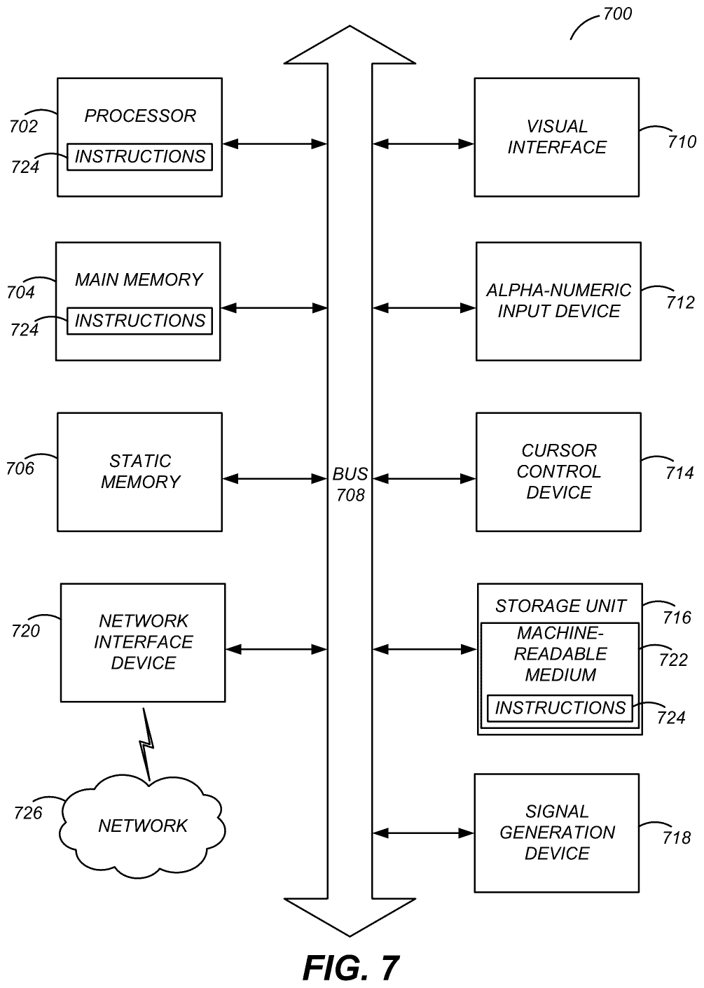

FIG. 7 is a block diagram illustrating components of an example machine able to read instructions from a machine-readable medium and execute them in a processor (or controller). Specifically, FIG. 7 shows a diagrammatic representation of a machine in the example form of a computer system 300 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 314 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

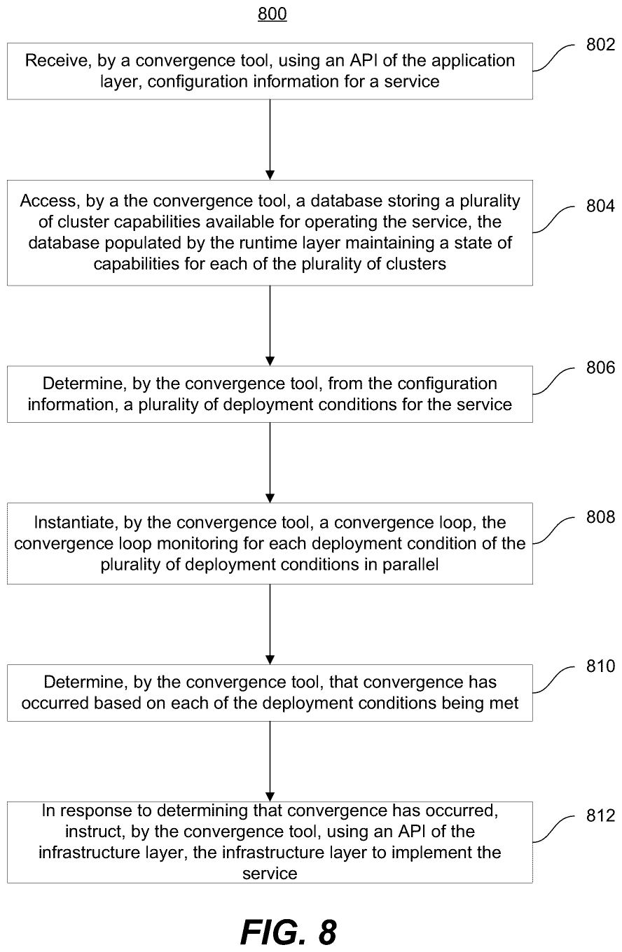

FIG. 8 is an exemplary process for running the convergence tool, in accordance with an embodiment. Process 800 may be effectuated by one or more processors (e.g., processor 702) executing instructions (e.g., instructions 724) that cause operation of the modules of convergence tool 130. Process 800 begins with convergence tool 130 receiving 802, using an API of the application layer, configuration information for a service (e.g., using application layer configuration module 202, and orchestrated by a runtime layer). Convergence tool 130 accesses 804 a database storing a plurality of cluster capabilities available for operating the service (e.g., capability database 252), the database populated by the runtime layer maintaining a state of capabilities for each of the plurality of clusters. Convergence tool 130 determines 806, from the configuration information, a plurality of deployment conditions for the service (e.g., by reading precondition database 250, populated at least in part by inputs from infrastructure layer configuration module 204 as orchestrated by the runtime layer).

Convergence tool 130 instantiates 808 a convergence loop, the convergence loop monitoring for each deployment condition of the plurality of deployment conditions in parallel (e.g., using deployment protections determination module 206). Convergence tool 130 determines 810 that convergence has occurred based on each of the deployment conditions being met (e.g., using convergence determination module 210). In response to determining that convergence has occurred, convergence tool 130 instructs 812, using an API of the infrastructure layer, the infrastructure layer to implement the service.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for orchestrating application protocol interfaces (APIs) of an infrastructure layer and an application layer using a runtime layer between the infrastructure layer and the application layer, the method comprising:
receiving, by a convergence tool, using an API of the application layer, configuration information for a service, the configuration information received using the runtime layer;
accessing, by the convergence tool, a database storing a plurality of cluster capabilities available for operating the service, the database populated by the runtime layer maintaining a state of capabilities for each of the plurality of clusters;
determining, by the convergence tool, from the configuration information, a plurality of deployment conditions for the service;
instantiating, by the convergence tool, a convergence loop, the convergence loop monitoring for each deployment condition of the plurality of deployment conditions in parallel;
determining, by the convergence tool, that convergence has occurred based on each of the deployment conditions being met; and
in response to determining that convergence has occurred, instructing, by the convergence tool, using an API of the infrastructure layer, the infrastructure layer to implement the service.

2. The method of claim 1, wherein at least two of the plurality of clusters use different data schemas with respect to one another.

3. The method of claim 2, wherein the state of capabilities maintained by the database are abstracted to a normalized data schema, and wherein data deployment of the service comprises performing a data mutation to the different data schemas on a per-cluster basis for the at least two of the plurality of clusters.

4. The method of claim 1, wherein the plurality of deployment conditions comprise interdependencies between at least two interdependent deployment conditions.

5. The method of claim 1, wherein instructing the infrastructure layer to implement the service comprises automatically authorizing the infrastructure layer to deploy the service without prompting a human.

6. The method of claim 1, wherein the configuration information comprises one or more preconditions for deploying the service, the one or more preconditions being a subset of the plurality of deployment conditions for the service, the plurality of deployment conditions comprising protections for deploying the service.

7. The method of claim 6, wherein instructing the infrastructure layer to implement the service comprises prompting a human with an alert that convergence has occurred based on the protections.

8. The method of claim 7, wherein the alert comprises a selectable option, and wherein the method further comprises responsive to detecting selection of the selectable option, deploying the service.

9. The method of claim 1, further comprising:
deploying the service; and
while the service is deployed, monitoring the service for compliance with the plurality of deployment conditions.

10. The method of claim 9, further comprising:
detecting that the service is not in compliance with at least one deployment condition of the plurality of deployment conditions; and
responsive to detecting that the service is not in compliance with at least one deployment condition of the plurality of deployment conditions, rolling back the service to an earlier version.

11. The method of claim 10, wherein the earlier version is a last known working version.

12. A non-transitory computer readable medium configured to store instructions, the instructions for orchestrating application protocol interfaces (APIs) of an infrastructure layer and an application layer using a runtime layer between the infrastructure layer and the application layer, the instructions, when executed by one or more processors, causing the processor to perform operations, the instructions comprising instructions to:
receive, by a convergence tool, using an API of the application layer, configuration information for a service, the configuration information received using the runtime layer;
access, by the convergence tool, a database storing a plurality of cluster capabilities available for operating the service, the database populated by the runtime layer maintaining a state of capabilities for each of the plurality of clusters;
determine, by the convergence tool, from the configuration information, a plurality of deployment conditions for the service;
instantiate, by the convergence tool, a convergence loop, the convergence loop monitoring for each deployment condition of the plurality of deployment conditions in parallel;
determine, by the convergence tool, that convergence has occurred based on each of the deployment conditions being met; and
in response to determining that convergence has occurred, instruct, by the convergence tool, using an API of the infrastructure layer, the infrastructure layer to implement the service.

13. The non-transitory computer-readable medium of claim 12, wherein at least two of the plurality of clusters use different data schemas with respect to one another.

14. The non-transitory computer-readable medium of claim 13, wherein the state of capabilities maintained by the database are abstracted to a normalized data schema, and wherein data deployment of the service comprises performing a data mutation to the different data schemas on a per-cluster basis for the at least two of the plurality of clusters.

15. The non-transitory computer-readable medium of claim 12, wherein the plurality of deployment conditions comprise interdependencies between at least two interdependent deployment conditions.

16. The non-transitory computer-readable medium of claim 12, wherein instructing the infrastructure layer to implement the service comprises automatically authorizing the infrastructure layer to deploy the service without prompting a human.

17. The non-transitory computer-readable medium of claim 12, wherein the configuration information comprises one or more preconditions for deploying the service, the one or more preconditions being a subset of the plurality of deployment conditions for the service, the plurality of deployment conditions comprising protections for deploying the service.

18. The non-transitory computer-readable medium of claim 17, wherein instructing the infrastructure layer to implement the service comprises prompting a human with an alert that convergence has occurred based on the protections.

19. The non-transitory computer-readable medium of claim 18, wherein the alert comprises a selectable option, and wherein the instructions further comprise instructions to, responsive to detecting selection of the selectable option, deploy the service.

20. A system comprising:
a non-transitory medium comprising memory with instructions encoded thereon for orchestrating application protocol interfaces (APIs) of an infrastructure layer and an application layer using a runtime layer between the infrastructure layer and the application layer; and
one or more processors that, when executing the instructions, are caused to perform operations comprising:
receiving, by a convergence tool, using an API of the application layer, configuration information for a service, the configuration information received using the runtime layer;
accessing, by the convergence tool, a database storing a plurality of cluster capabilities available for operating the service, the database populated by the runtime layer maintaining a state of capabilities for each of the plurality of clusters;
determining, by the convergence tool, from the configuration information, a plurality of deployment conditions for the service;
instantiating, by the convergence tool, a convergence loop, the convergence loop monitoring for each deployment condition of the plurality of deployment conditions in parallel;
determining, by the convergence tool, that convergence has occurred based on each of the deployment conditions being met; and
in response to determining that convergence has occurred, instructing, by the convergence tool, using an API of the infrastructure layer, the infrastructure layer to implement the service.
